(19) United States
(12) Patent Application Publication
(10) Pub. No.: US 2005/0086528 A1
(43) Pub. Date: Apr. 21, 2005

(54) Method for hiding information on a computer

(75) Inventors: Ron Darziv, Portland, OR (US); Yanki Margalit, Ramat-Gan (IL); Dany Margalit, Ramat-Gan (IL)

Correspondence Address: DR. MARK FRIEDMAN LTD.;c/o Bill Polkinghorn, Discovery Dispatch, 9003 Florin Way, Upper Marlboro, MD, 20772, US

(73) Assignee: ALADDIN KNOWLEDGE SYSTEMS LTD.

(21) Appl. No.: 10/688,995

(22) Filed: Oct. 21, 2003

(51) Int. Cl. H04L 9/00

(52) U.S. Cl. 713/201

(57) ABSTRACT

A method for hiding information on a computer, comprising: storing said information in one or more storage entries (e.g. file, registry entry), having a name that is derived in a secret manner from the identity (e.g. serial number) of one or more computer components. According to a preferred embodiment of the invention, deriving a name in a secret manner from the identity of one or more computer components is carried out by: generating a pseudo-random sequence, the seed of said sequence derived from the identity of said one or more computer components; and deriving a name from one or more value of said pseudo-random sequence. The computer components may be hardware and/or software modules, e.g. CPU, a computer chip, a computer program, the BIOS, a file (the name of a file, the ID of a file, the physical location of a file), the volume name of a disk, etc.

### FIELD OF THE INVENTION

The present invention relates to the field of information security. More particularly, the invention relates to a method for hiding information on a computer.

### BACKGROUND OF THE INVENTION

It is common to store licensing-related information on non-volatile storage means at the user's computer, e.g. in a file or a registry entry (whenever the operating system supports a registry, like Windows). For example, in a Try-Before-You-Buy commercial scheme, where the user is allowed to use an application program for a trial period, a limited number of executions, etc., the starting date of the trial period and/or the times the application has been executed is usually kept on the user's computer.

In order to harden the ability to “hack” of the information, it is common to store the information in an encrypted mode. It is also common to store the information in a plurality of storage entries, like several files and registry entries, thereby forcing the hacker to detect all the entries. Typically a software application takes into consideration the most reasonable information of all the storage entries. For example, the protection scheme may take into consideration the earliest date of all the retrieved dates. Consequently, a hacker that tries to break the protection shield of a software application has to find all its storage entries.

But the need to hide information on a computer is much more general than the need of software manufacturers to keep user-information of their product out of the reach of hackers. The same requirements occur whenever program “state” must be kept locally and must be protected from tampering or accidental loss. For example, currently many multiplayer games are implemented using peer-to-peer technology, resulting in a “serverless” environment where none of the machines can be trusted. In that situation, keeping the game data secure may be important (for some types of games). In another example, many DRM vendors provide restrictions on the number of times an audio track or video may be played. In this case, if no server is involved, each time the media is played the problem of preventing the use information from being deleted rises.

The collection of files and/or registry entries that is used for this purpose is commonly referred to as “secure storage.”

Another common practice is to use a “hardware fingerprint” to distinguish one computer from another. Various hardware characteristics, such as network card MAC addresses, hard disk serial numbers, the amount of physical memory, and so on are used as inputs to cryptographic digest algorithms, resulting in a large random number that is very unlikely to be duplicated by any other computer. Software licensing systems use these “hardware fingerprints” to determine that the licensed software has not been copied without authorization. Hardware fingerprints are also commonly used in communication protocols when sending information from a client computer to a server. This gives the server a strong authentication factor that may be used in combination with other authentication factors, such as a login name and password, to provide proof of identity.

It is therefore an object of the present invention to provide a method for hiding information on a computer.

It is a further object of the present invention to provide a method for preventing a hacking method, which breaks the protection shield of a given computer, from being implemented on other computers—i.e. to require a different hacking method on each different computer.

Other objects and advantages of the invention will become apparent as the description proceeds.

### SUMMARY OF THE INVENTION

A method for hiding information on a computer, said method comprising the steps of: storing said information in one or more storage entries (e.g. file, registry entry), having a name that is derived in a secret manner from the identity (e.g. serial number) of one or more computer components. According to a preferred embodiment of the invention, deriving a name in a secret manner from the identity of one or more computer components is carried out by: generating a pseudo-random sequence, the seed of said sequence derived from the identity of said one or more computer components; and deriving a name from one or more values of said pseudo-random sequence. The computer components may be hardware and/or software modules, e.g. CPU, a computer chip, a computer program, the BIOS, a file (the name of a file, the ID of a file, the physical location of a file), the volume name of a disk, etc.

### BRIEF DESCRIPTION OF THE DRAWINGS

The present invention may be better understood in conjunction with the following figures:

FIG. 1 schematically illustrates a high-level flowchart of method for hiding information on a computer, according to a preferred embodiment of the invention.

FIG. 2 schematically illustrates a high-level flowchart of the operation of reading hidden information on a computer, according to a preferred embodiment of the invention. Blocks 20-22 correspond to blocks 10-12 respectively.

FIG. 3 schematically illustrates a high-level flowchart of a method for hiding information on a computer, according to a preferred embodiment of the invention.

FIG. 4 schematically illustrates a high-level flowchart of the operation of reading hidden information on a computer, according to a preferred embodiment of the invention.

### DETAILED DESCRIPTION OF PREFERRED EMBODIMENTS

The term “identity of a computer component” refers herein to a string that characterizes the computer component, and can be retrieved by computer means. For example, each CPU chip manufactured by Intel has a unique serial number, each manufactured hard disk has a unique serial number, each network card has a unique MAC (Media Access Control) address, and so forth. Sometimes software manufacturers also add a serial number to their products, under the Windows operating system a disk has a volume name, etc. The serial numbers as well as the model type of the computer components can be retrieved by computer means, such as software and/or hardware. The identity of a computer component can also be derived from the type of the component. (Actually, the user can control the ability to retrieve Intel's CPU number, and the default is that this number is confidential. However, in cases where this number is available, it can be used for constructing a fingerprint.)

According to the present invention, protected information is stored in one or more storage entries, where the identity of each storage-entry is derived in a confidential manner from the identity of one or more computer components.

Thus, the following elements characterize the invention:
a) Deriving a name from the identity of one or more computer components in a confidential manner.
b) Storing the protected information in a storage entry based on said name.

According to a preferred embodiment of the invention, the protected information is stored in one or more storage entries (e.g. files, registry entries, etc.) for which their name is derived from one or more members of a pseudo-random sequence whose seed is based on a numeric value derived from the identity of computer components (e.g. serial numbers). One method of deriving the seed is to use a cryptographic digest algorithm such as MD5 or SHA1. Nowadays, there are a variety of well-known algorithms for providing very random pseudo-random sequences starting with a given value, such as using DES, DESX, or AES to successively encrypt the previous value.

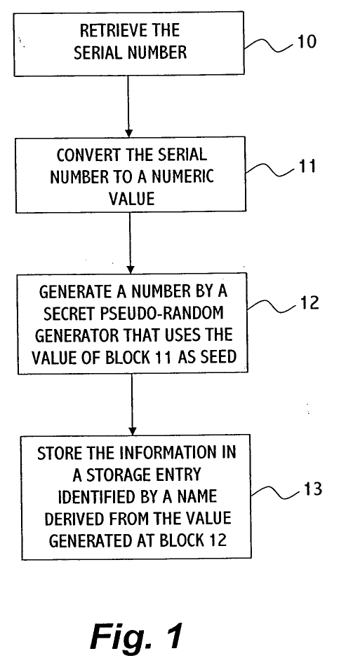

FIG. 1 schematically illustrates a high-level flowchart of a method for hiding information on a computer, according to a preferred embodiment of the invention.

At block 10, the serial number of a computer component is retrieved, for example, the serial number of the hard drive. As known to a person of ordinary skill, the serial number of a computer component can be retrieved by software means. Thus, the serial number of the hard drives can be retrieved a in this way, the MAC address, etc. Moreover, software components usually also have a serial number, which can be retrieved by software tools.

At block 11, if the serial number also comprises characters, it is converted to a numeric value. For example, the serial number XYZ667733-4334-EB566 can be converted to a numeric value in a variety of ways, e.g., by using the MD5 digest algorithm.

At block 12, the numerical value generated at block 11 is used as the seed for a pseudo-random sequence generator, and one or more pseudo-random values are generated. For example, the generated pseudo-random number might be 7345213143565334. The number sequences derived using cryptographic algorithms may have as many digits as desired.

At block 13, the protected information is stored in a storage entry whose identity is derived from the pseudo-random number generated at block 12. The number of digits used by the corresponding file or registry name need not always be the same. Using a different number of digits will help prevent obvious patterns that may help a hacker. For example, the number of digits used might be determined by 4 plus the last digit of the number itself, so in this example the number used would be only the last 8 digits, or 43565334. Obviously, some manipulation can be carried out using this number, like multiplying this number by a predetermined value, by the next value of the pseudo-random sequence, etc.

If the storage media is the registry of a computer, than the storage identity, i.e. 43565334, etc. refers to the registry entry. If the storage media is a file, than the storage identity may refer to a file name (e.g. c:\Temp\abc43565334.dat, etc.). Obviously, other storage media can be used, e.g. a database, INI files (of the Windows family operating system), etc. Also, prefixes or suffixes may be combined with the number, or the number may be converted back into a string by some algorithm such as base64 MIME encoding, prior to use as a registry entry or file name.

According to a preferred embodiment of the invention, the method used for generating the pseudo-random numbers should be known only to the software module that stores the protected information, and the software module that reads the protected information. This way a hacker that “breaks” the protection shield on one computer cannot implement this method to other computers.

Obviously the information can be stored in a secured manner, e.g. encrypted, digitally signed, etc., thereby keeping the content of the protected information away from a potential hacker or preventing the modification of the information by an unauthorized object.

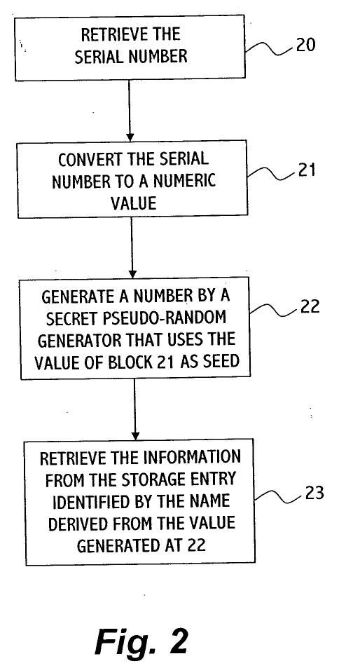

FIG. 2 schematically illustrates a high-level flowchart of the operation of reading hidden information on a computer, according to a preferred embodiment of the invention. Blocks 20-22 correspond to blocks 10-12 respectively. At block 23, the information from the storage entry identified by the name derived from the value generated at 22 is read. If the information is secured, a corresponding action should be performed. For example, if the protected information is encrypted, then at this stage it should be decrypted. If the information is digitally signed, at this stage the digital signature should be verified.

Of course, the security can be carried out by a variety of methods known in the art, e.g. symmetric or asymmetric encryption, etc. Moreover, the keys can be derived from the pseudo-random sequence mentioned at blocks 12 and 22.

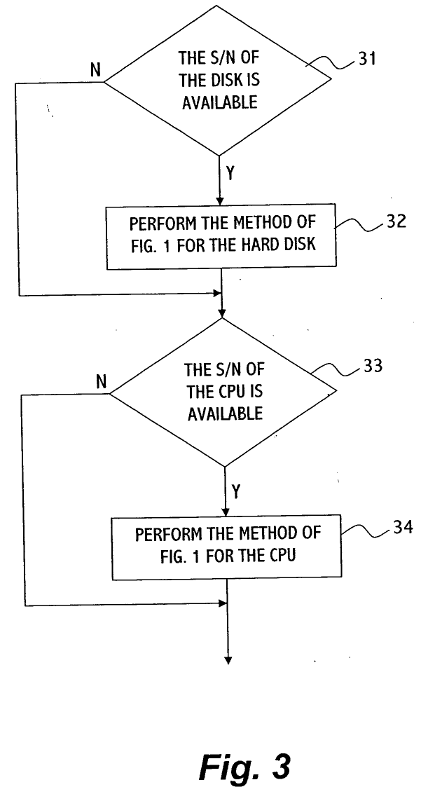

FIG. 3 schematically illustrates a high-level flowchart of a method for hiding information on a computer, according to a preferred embodiment of the invention. The method described in FIG. 1 is implemented for two computer components, the hard drive and the CPU. From block 31, if the serial number (S/N) of the disk if available, then at block 32 the information is hidden as described in FIG. 1. From block 33, if the serial number (S/N) of the CPU if available, then at block 34 the information is hidden as described in FIG. 1. Actually, this can be carried out for a predefined list of computer components. Each component might correspond to one or more files, or a collection of components might be used together to seed a sequence. Moreover, the installed components can be found at the place where the operating system stores such information, e.g. the registry and INI files (at the Windows operating system), in user-specific (e.g. “Documents and Settings” in the Windows operating system) or in user-shared locations, etc. Thus the information may be duplicated.

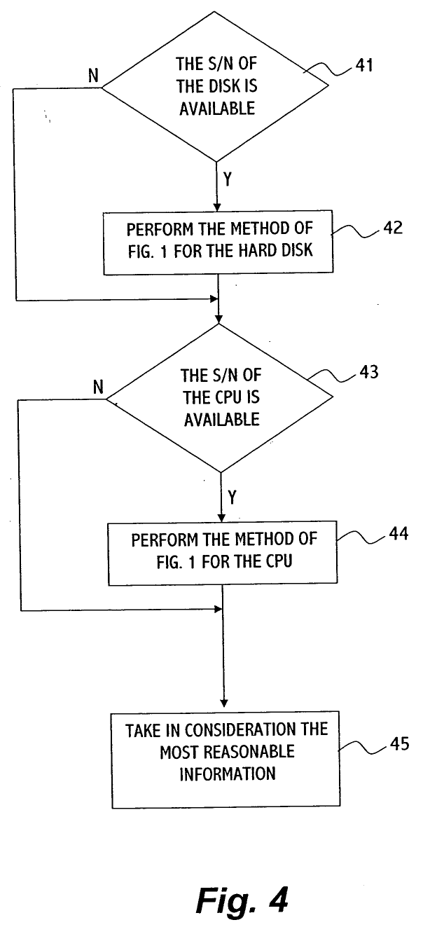

FIG. 4 schematically illustrates a high-level flowchart of the operation of reading hidden information on a computer, according to a preferred embodiment of the invention. Blocks 41-44 correspond to blocks 31-34 respectively. Since the information is duplicated, at block 44 the most reasonable information is taken into consideration. For example, if the protected information comprises the number of times a program has been executed in a Try-Before-You-Buy scheme, and the retrieved information from the storage entry that corresponds to the hard disk indicates 10 executions while the retrieved information from the storage entry that corresponds to the hard disk indicates 15 executions, it is obvious that the information that should be taken into consideration is 15 executions. There is a reasonable chance that the information that indicates 10 executions has been pre-stored by a hacker, and the current information has been replaced by the stored one.

Storing the protected information in a plurality of storage entries, such that each storage entry corresponds to a different computer element (or group of computer elements), enables replacing computer components without affecting the functionality of the method. For example, if the network card is replaced, and consequently the program that retrieves the protected information cannot find it in the expected place, the protected information can still be found in a storage entry that corresponds to the hard disk. The next time the protected information is stored, it will be in a storage entry that corresponds to the MAC (Media Access Control) address of the new network card.

It should be noted that the computer components from which the name of the storage entry is derived, may also be accessible remotely, e.g. over a LAN (Local Area Network). The same applies to the location entries used for storing the protected information.

Those skilled in the art will appreciate that the invention can be embodied by other forms and ways, without losing the scope of the invention. The embodiments described herein should be considered as illustrative and not restrictive.

1. A method for securely storing information on a computer, said method comprising the steps of:
a) retrieving an identity of at least one computer component;
b) deriving at least one identifier from said identity of said at least one computer component; and
c) for each of said at least one identifier, storing said information on said computer in a storage entry corresponding to said identifier.

2. A method according to claim 1, wherein said deriving at least one identifier from said identity of said at least one computer component, is carried out in a secret manner.

3. A method according to claim 1, wherein said information is encrypted prior to said storing of said information.

4. A method according to claim 1, wherein said storage entry is selected from the group comprising: a file, a registry entry, a database entry.

5. A method according to claim 1, wherein said identity is selected from the group comprising: a serial number, a type number, a physical location, a network address.

6. A method according to claim 1, wherein said at least one computer component is selected from the group comprising: a hard drive, a network card, a CPU, a computer chip, a software element, a hardware element, a BIOS, a file, a name of a file, an ID of a file, a physical location of a file, a program.

7. A method according to claim 1, wherein said deriving of said at least one identifier from said identity of said at least one computer component is carried out by the steps:
a) generating a pseudo-random sequence whose seed is derived from said identity; and
b) deriving said at least one identifier from at least one member of said pseudo-random sequence.

8. A method according to claim 1, wherein said at least one computer component is remotely accessible by said computer.

9. A method according to claim 1, wherein said at least one storage entry is remotely accessible by said computer.

10. A method for securely storing information on a computer and retrieving said information, said method comprising the steps of:
storing said information by:
a) retrieving an identity of at least one computer component;
b) deriving at least one identifier from said identity of said at least one computer component;
c) for each of said at least one identifier, storing said information on said computer in a storage entry corresponding to said identifier;
retrieving the stored information by:
d) retrieving the identity of said at least one computer component;
e) deriving in the manner of step (b) said at least one identifier from said identity of at least one computer component;
f) for each of said at least one identifier, retrieving said information on said computer from a storage entry corresponding to said identifier;

11. A method according to claim 10, wherein said deriving at least one identifier from said identity of at least one computer component, is carried out in a secret manner.

12. A method according to claim 10, wherein said information is encrypted prior to said storing of said information.

13. A method according to claim 10, wherein said storage entry is selected from the group comprising: a file, a registry entry, a database entry.

14. A method according to claim 10, wherein said identity is selected from the group comprising: a serial number, a type number, a physical location, a network address.

15. A method according to claim 10, wherein said at least one computer component is selected from the group comprising: a hard drive, a network card, a CPU, a computer chip, a software element, a hardware element, a BIOS, a file, a name of a file, an ID of a file, a physical location of a file, a program.

16. A method according to claim 10, wherein said deriving of said at least one identifier from said identity of said at least one computer component is carried out by steps including:
a) generating a pseudo-random sequence whose seed is derived from said identity; and
b) deriving said at least one identifier from at least one member of said pseudo-random sequence.

17. A method according to claim 10, wherein said at least one computer component is remotely accessible by said computer.

18. A method according to claim 10, wherein said at least one storage entry is remotely accessible by said computer.
